(19) United States
(12) Patent Application Publication
(10) Pub. No.: US 2015/0130103 A1
(43) Pub. Date: May 14, 2015

(54) METHOD OF MAKING A MANIKIN WITH AN EMBEDDED STAND COMPONENT

(71) Applicants: Dawayne Dewey, Cody, WY (US); Rick Morgan, Raleigh, NC (US)

(72) Inventors: Dawayne Dewey, Cody, WY (US); Rick Morgan, Raleigh, NC (US)

(21) Appl. No.: 14/538,433

(22) Filed: Nov. 11, 2014

Related U.S. Application Data
(60) Provisional application No. 61/902,624, filed on Nov. 11, 2013.

(51) Int. Cl. G09B 23/36; B29C 44/56

(52) U.S. Cl. CPC G09B 23/36; B29C 44/569; B29L 2031/702
USPC 264/46.6

(57) ABSTRACT

A method of making a foam manikin with a stand is provided. The method includes sculpting a sculpture of the manikin and forming the sculpture around a mating portion. Then a mold is formed using the sculpture. The mold may include an opening that is formed around the mating portion. The mold may be made in a plurality of pieces and may be taken apart and put back together. To form the manikin, the mold is secured around the mating portion and the mold is filled with a foam. Once filled with foam, the manikin is formed with at least a portion of the mating portion embedded within. The mating portion may be releasably attached to a stand so that the manikin may stand in an upright position.

### CROSS-REFERENCE TO RELATED APPLICATION

This application claims the benefit of priority of U.S. provisional application No. 61/902,624, filed Nov. 11, 2013, the contents of which are herein incorporated by reference.

### BACKGROUND OF THE INVENTION

The present invention relates to a method of making a manikin and, more particularly, to a method of making a manikin with an embedded receiver.

Generally, in the field of taxidermy, it is desired to have a taxidermy manikin standing in an upright position, on a premade elevated base or pedestal. Currently, if one would like to have the taxidermy manikin standing in the upright position, and not set on the floor or hung on a wall, a user would have to purchase various parts. Then the user would have to drill into the manikin and assemble the various parts using tools, glues and fillers. This process is difficult, time consuming and mistakes may be made.

As can be seen, there is a need for an easier method of including a stand for a taxidermy manikin to set upright on a premade base or pedestal.

### SUMMARY OF THE INVENTION

In one aspect of the present invention, a method of making a manikin with a stand comprises: sculpting a sculpture of the manikin, wherein the sculpture is formed around a mating portion and wherein the mating portion is protruding from a surface of the sculpture; forming a mold of the sculpture, wherein the mold comprises an opening formed around the mating portion; removing the sculpture from the mold; securing the mold around the mating portion so that at least a portion of the mating portion is protruding through the opening of the mold; and filling the mold with a foam to form the manikin so that at least a portion of the mating portion is embedded within the manikin.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an exploded view of the present invention;

FIG. 3 is a section view of the present invention, taken along line 3-3 in FIG. 1, illustrated with foam filling the cavity;

FIG. 4 is a detail section view of the present invention; and

FIG. 5 is a section view of the present invention, taken along line 5-5 in FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of making a foam manikin with a stand. The method includes sculpting a sculpture of the manikin and forming the sculpture around a mating portion. Then a mold is formed using the sculpture. The mold may include an opening that is formed around the mating portion. The mold may be made in a plurality of pieces and may be taken apart and put back together. To form the manikin, the mold is secured around the mating portion and the mold is filled with a foam. Once filled with foam, the manikin is formed with at least a portion of the mating portion embedded within. The mating portion may be releasably attached to a stand so that the manikin may stand in an upright position. The present invention may be used during taxidermy.

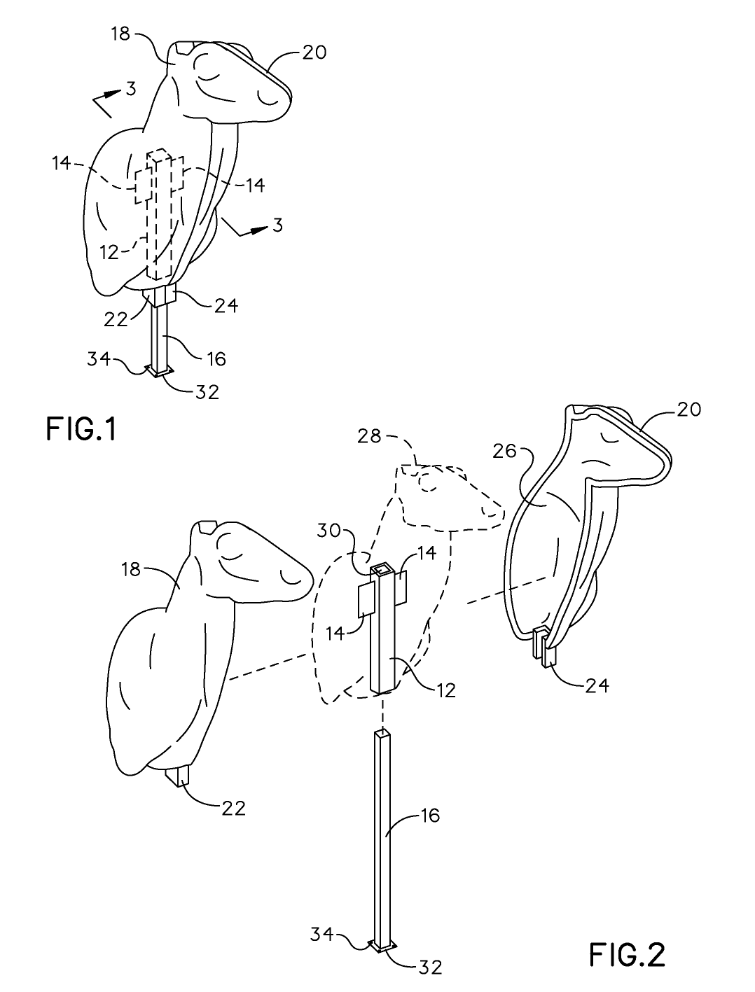

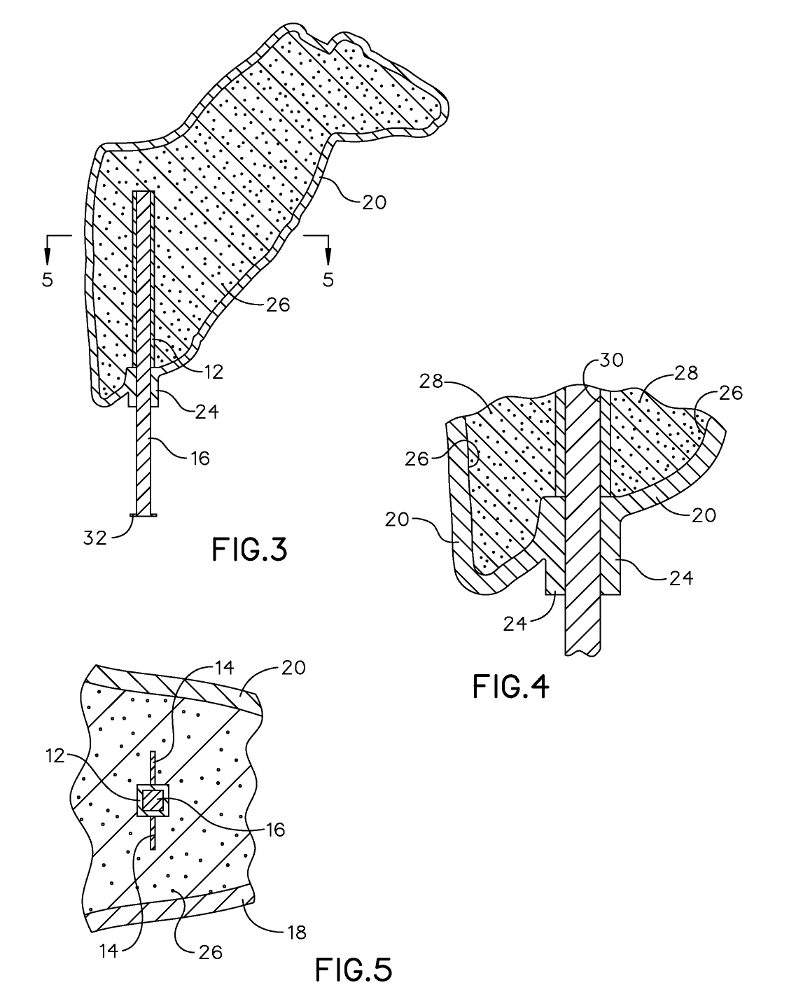

Referring now to FIGS. 1 through 5, the present invention includes a foam manikin 28 with an embedded mating portion 12, 16. The foam manikin 28 is formed by using a mold 18, 20. The mold 18, 20 may be broken down into a plurality of pieces, including a first half 18 and a second half 20 with an internal portion 26. The first half 18 and second half 20 of the mold 18, 20 are assembled together, surrounding the mating portion 12, 16. The mold 18, 20 is then injected with foam to form the foam manikin 28 with the embedded mating portion 12, 16.

In certain embodiments, the mating portion 12, 16 includes a first mating portion, such as a slot receiver 12 and a second mating portion, such as a peg 16. As illustrated in the Figures, the peg 16 fits in the inside 30 of the slot receiver 12 and is thereby releasably attachable to the slot receiver 12. The mold 18, 20 may be assembled around the peg 16 and the peg 16 may be exposed out of the bottom of the mold 18. In certain embodiments, mold flanges 22, 24 hold the peg 14 in place. A first half 22 of the mold flanges 22, 24 may protrude from the first half 18 of the mold 18, 20 and a second half 24 of the mold flanges 22, 24 may protrude from the second half 20 of the mold 18, 20. Foam is injected into the mold 18, 20 and surrounds the slot receiver 12. Once the foam has been injected and has filled the mold 18, 20, the mold 18, 20 may be disassembled. In such embodiments, the receiver 12 is embedded in the foam manikin 28. In certain embodiments, fins 14, such as two fins 14, are attached to the outside surface of the receiver 12 to further stabilize the receiver 12 within the manikin 28.

As illustrate in the Figures, once the product is done, the receiver 12 remains embedded and inside the foam of the manikin 28. In certain embodiments, the peg 16 may be removed from the receiver 12 and inserted back into the receiver 12. The fins 14 stabilize and secure the receiver 12 in the foam 16 and are depicted as being attached to the receiver 12 and embedded in the foam 16. In certain embodiments, a plate 32 is attached to the bottom of the peg 14 so that the peg 14 may act as a stand. The plate 24 may further be screwed to a wood or metal display using screws 34 to secure and stabilize the stand.

FIG. 5 provides a bottom cross sectional view of the mold 18, 20 including the slot receiver 12 with the peg 16 inside the slot receiver 12. As can be seen, the mold 18 is assembled around the peg 16. The peg 16 fits through the opening of the mold 18, 20 once assembled. In certain embodiments, the mold flanges 22, 24 form the opening and fit around the peg 14. Once the mold 18, 20 is assembled around the peg 16 and the receiver 12, the foam 26 is injected into the mold 18, 20, embedding the receiver 12 into the manikin 28.

A method of preparing the present invention may include the following. First a sculpture is made to depict a desired shape and size of the manikin. In certain embodiments, the sculpture is sculpted out of clay, however it is envisioned that the sculpture may be made of any material known in the art used for sculpting. In certain embodiments, the sculpture is made with the peg embedded in the sculpture. The peg may be located at the bottom of the sculpture. Once the sculpture is complete, a mold is made around the sculpture. The mold may resemble an outline of the sculpture and may include an opening at the bottom of the mold where the peg fits through.

The mold may include a plurality of pieces that fit together. In an embodiment of the present invention, the mold is disassembled prior to the foam molding process. The peg may be removed from the sculpture, or a different peg with similar dimensions may be used. The receiver is slid onto the peg. The mold may then be assembled around the peg and receiver, with the end of the peg exposed through the opening of the mold. Once the mold is assembled around the peg, with the receiver slide over top the peg, the mold is injected with foam. The foam may fill the mold and secures the receiver within foam. Once the mold is filled with the foam, the mold may be disassembled, revealing a foam manikin with an embedded receiver on the bottom.

In certain embodiments, the receiver is hollow and may receive the peg. The receiver may be made of a metal, plastic, wood or any material that may securely support the foam manikin. Embodiments of the present invention also provide a receiver including fins. The fins may be attached to the receiver and may protrude laterally from the receiver. The fins may further secure the receiver within the foam. Other embodiments to secure the receiver within the foam may include, but are not limited to, spikes, barbs, serrated surface, protrusions, or the like.

In certain embodiments, the peg may be made of metal, plastic, wood or any material that may securely support the foam manikin. The peg may have a square, circular, parallelogram, triangular or any shape in which the peg may fit into the receiver. The peg may further include a plate on the bottom to further stabilize that peg when propped up on the display stand. Screws may secure the plate to the display stand.

In certain embodiments, the peg rather than the receiver is embedded into the foam manikin. The steps include fitting the peg into the opening of the assembled mold without the receiver on the peg. The foam is then injected into the mold and the foam surrounds and secures the peg. Once the mold is removed, the peg may support the manikin without needing the receiver. The peg may be propped up by a plate, external receiver, tripod or any means in which the peg may be stabilized and secured.

It should be understood, of course, that the foregoing relates to exemplary embodiments of the invention and that modifications may be made without departing from the spirit and scope of the invention as set forth in the following claims.

What is claimed is:

1. A method of making a manikin with a stand comprising:
sculpting a sculpture of the manikin, wherein the sculpture is formed around a mating portion and wherein the mating portion is protruding from a surface of the sculpture;
forming a mold of the sculpture, wherein the mold comprises an opening formed around the mating portion;
removing the sculpture from the mold;
securing the mold around the mating portion so that at least a portion of the mating portion is protruding through the opening of the mold; and
filling the mold with a foam to form the manikin so that at least a portion of the mating portion is embedded within the manikin.

2. The method of claim 1, wherein the mating portion comprises a first mating portion and a second mating portion releasably securable to the first mating portion.

3. The method of claim 2, wherein the first mating portion is a slot receiver and the second mating portion is a peg.

4. The method of claim 3, further comprising at least one receiver fin protruding from an outside surface of the slot receiver.

5. The method of claim 4, wherein the at least one receiver fin is two receiver fins.

6. The method of claim 3, wherein sculpting the sculpture of the manikin comprises the sculpture formed around the peg.

7. The method of claim 6, further comprising the step of inserting the peg into the slot receiver, and securing the mold around the slot receiver so that the slot receiver is within the mold and the peg is protruding from the opening prior to filling the mold with the foam.

8. The method of claim 7, wherein a protruding flange is formed on the surface of the mold forming the opening, wherein the peg is protruding from the flange prior to filling the mold with foam.

9. The method of claim 7, further comprising the step of removing the peg from the slot receiver after filling the mold with foam, wherein the slot receiver is embedded in the foam.

10. The method of claim 9, further comprising the step of mounting the peg to a stand.
